(19) United States
(12) Patent Application Publication
(10) Pub. No.: US 2013/0323163 A1
(43) Pub. Date: Dec. 5, 2013

(54) METHOD FOR PRODUCING TITANO-(SILICO)-ALUMINO-PHOSPHATE

(71) Applicants: Silke Sauerbeck, Bruckmuhl OT Heufeld (DE); Oliver Rauch, Augsburg (DE); Arno Tissler, Tegernheim (DE); Roderik Althoff, Rosenheim (DE)

(72) Inventors: Silke Sauerbeck, Bruckmuhl OT Heufeld (DE); Oliver Rauch, Augsburg (DE); Arno Tissler, Tegernheim (DE); Roderik Althoff, Rosenheim (DE)

(73) Assignee: Clariant Produkte (Deutschland) GmbH, Frankfurt am Main (DE)

(21) Appl. No.: 13/996,814

(22) PCT Filed: Dec. 21, 2011
(86) PCT No.: PCT/EP11/73553

§ 371 Date: Aug. 14, 2013

(30) Foreign Application Priority Data
Dec. 22, 2010 (DE) 10 2010 055 730.7

(51) Int. Cl. B01J 29/89

(52) U.S. Cl. CPC B01J 29/89
USPC 423/700

(57) ABSTRACT

The invention relates to a method for producing titano-(silico)-alumino-phosphate, a catalyst shaped body which contains titano-(silico)-alumino-phosphate, a washcoat containing titano-(silico)-alumino-phosphate, the use of the washcoat to produce a catalyst by coating a support body, and to the use of titano-(silico)-alumino-phosphate or of the catalyst shaped body to produce a catalyst.

The present invention relates to a novel method for producing titano-alumino-phosphate or titano-silico-alumino-phosphate (hereafter called titano-(silico)-alumino-phosphate), a catalyst shaped body which contains titano-(silico)-alumino-phosphate, a washcoat containing titano-(silico)-alumino-phosphate, the use of the washcoat to produce a catalyst by coating a support body, as well as the use of titano-(silico)-alumino-phosphate or of the catalyst shaped body to produce a catalyst.

In the state of the art alumino-silicates (zeolites), alumino-phosphates (ALPOs) and silico-alumino-phosphates (SAPOs) have for a long time been known as active components for refinery, petrochemical and chemical catalysts as well as for exhaust gas purification in both stationary and mobile applications. These groups are often also referred to only by the collective term zeolites.

Generally, by silico-alumino-phosphates (SAPOs) are meant molecular sieves that are obtained starting from alumino-phosphates (general formula (AlPO₄-n)) by isomorphic exchange of phosphorus with silicon and correspond to the general formula (SiₓAl_{y}P_{z})O₂ (anhydrous) (EP 0 585 683), wherein x+y+z is approximately equal to 1 and the species has negative charges, the number of which depends on how many phosphorus atoms have been replaced by silicon atoms, or the number of which depends on how great the excess of aluminium atoms is with respect to the phosphorus atoms.

Structures of this group are graded by the “Structure Commission of the International Zeolite Association” on the basis of their pore sizes according to IUPAC rules (International Union of Pure and Applied Chemistry). They crystallize into more than 200 different compounds in two dozen different structures. They are classified on the basis of their pore sizes.

SAPOs can typically be obtained by means of hydrothermal synthesis, starting from reactive alumino-phosphate gels, or the individual Al, Si, P components, which are used in stoichiometric ratio. The crystallization of the obtained silico-alumino-phosphates (SAPOs) is achieved by means of the addition of structure-directing templates, crystal nuclei or elements (EP 103 117 A1, U.S. Pat. No. 4,440,871, U.S. 7,316,727).

The framework structure of the silico-alumino-phosphates (SAPOs) is constructed from regular, three-dimensional spatial networks with characteristic pores and channels that can be connected to each other in one, two or three dimensions. The above-mentioned structures are formed from corner-connected tetrahedral units (AlO₄, SiO₄, PO₄), consisting of aluminium, silicon and phosphorus, tetracoordinated by oxygen in each case. The tetrahedra are called primary structural units the connecting of which results in the formation of secondary structural units. Silico-alumino-phosphates (SAPOs) crystallize inter alia in the known CHA structure (chabazite), classified according to IUPAC on the basis of their specific CHA structural unit.

In the alumino-phosphates there is charge neutrality because of the equal number of aluminium and phosphorus atoms. These systems thus have the disadvantage that they require no counterions in the voids to equalize the charge. Thus it is also not possible to effectively incorporate cations into these voids by ion binding.

As a result of the isomorphic exchange/replacement of phosphorus with silicon, surplus negative charges which are compensated for by the incorporation of additional cations into the pore and channel system form in silico-alumino-phosphates (SAPOs). The level of phosphorus-silicon substitution thus determines the number of cations required for balancing, and thus the maximum charging of the compound with positively charged cations, e.g. hydrogen or metal ions. The acid catalytic properties of the silico-alumino-phosphates (SAPOs) are determined by the incorporation of the cations and can be used as catalyst components by means of targeted ion exchange with respect to their activity and selectivity. The so-called SAPO-34 with CHA structure and pore openings of 3.5 Å is particularly preferably used as molecular sieve in catalysts. However, these silico-alumino-phosphates have the disadvantage that they are relatively thermally unstable in the aqueous phase. Thus e.g. SAPO-34 already amorphizes at low temperatures—inter alia already during the production of the catalyst in aqueous phases.

So-called titano-silico-alumino-phosphates have also been known for many years (EP 161 488) as a similar substance class and, because of their similar properties, are as much in demand as silico-alumino-phosphates. However, the previously known synthesis (EP 161 488) of such titano-silico-alumino-phosphates has disadvantages. Thus, for example, titano-organyl compounds are used as titanium source to produce the titano-silico-alumino-phosphate. These organyl compounds are expensive on the one hand and, on the other, they result in an increased pressure in the autoclave. Special autoclaves which are able to withstand this increased pressure are therefore necessary for titano-organyl compounds. In addition, the explosion risk significantly increases when titano-organyl compounds are used.

It is thus desirable to provide a method for producing titano-(silico)-alumino-phosphates which is simpler, more cost-effective and more environmentally friendly than the methods known in the state of the art.

The object of the present invention was thus to provide a molecular sieve for use in catalysts which has a high phase purity, a high temperature stability, a high metal loading rate and/or a high storage capacity for water for use as heat storage medium, for ammonia in the field of selective catalytic reduction (SCR) and for hydrocarbons in the field of diesel oxidation catalysts (DOC), and which is simple, cost-effective and environmentally friendly in production.

The object of the present invention is achieved by providing a method for producing titano-(silico)-alumino-phosphate by thermal conversion of a mixture, wherein the mixture comprises a titanium source, an aluminium source, a phosphorus source and optionally a silicon source. The method is characterized in that the titanium source comprises or consists of TiO₂ and/or silicon-doped TiO₂.

Like the above-named SAPOs, the titano-(silico)-alumino-phosphates within the context of the present invention are crystalline substances with a spatial network structure which consists of TiO₄/AlO₄/(SiO₄)/PO₄ tetrahedra and is linked by common oxygen atoms to form a regular three-dimensional network. All these named tetrahedron units together form the so-called “framework”. Further units, which do not consist of the tetrahedron units of the base framework, are referred to as so-called “extra framework”.

The structures of the titano-(silico)-alumino-phosphates contain voids which are characteristic of each structural type. They are divided into different structures according to their topology. The crystal framework contains open voids in the form of channels and cages which are normally occupied by water molecules and additional framework cations which can be replaced. In the case of the so-called alumino-phosphates, at least in the “framework” of the titano-(silico)-alumino-phosphate, there is one phosphorus atom for each aluminium atom, with the result that the charges cancel each other out. If titanium atoms are substituted for the phosphorus atoms, the titanium atoms form an excess negative charge which is compensated for by cations. The inside of the pore system represents the catalytically active surface. The less phosphorus a titano-(silico)-alumino-phosphate contains relative to aluminium in the framework, the denser the negative charge is in its lattice and the more polar its inner surface is. The pore size and structure are determined, in addition to the parameters during production, i.e. use or type of templates, pH, pressure, temperature, presence of seed crystals, by the P/Al/Ti/(Si) ratio which accounts for the greatest part of the catalytic character of a titano-alumino-phosphate or titano-(silico)-alumino-phosphate. The substitution of titanium atoms for phosphorus atoms with respect to the framework gives rise to a deficit of positive charges, with the result that the molecular sieve is negatively charged overall. The negative charges are compensated for by incorporating cations into the pores of the zeolite material. In addition to titanium atoms, silicon atoms can also replace the phosphorus atoms as can be seen from the above-mentioned optional presence of silicon placed in brackets. These then also give rise to a negative charge, which has to be compensated for by cations. The titano-(silico)-alumino-phosphate produced according to the method according to the invention is preferably present in its so-called H⁺ form after its production. In this case, H⁺ ions form the counterions which neutralize the negative charge of the molecular sieve. In this way, Bronstedt acid properties are induced.

The titano-(silico)-alumino-phosphates produced with the method according to the invention are differentiated—as also in the state of the art—mainly according to the geometry of the voids which are formed by the rigid network of the TiO₄/AlO₄/(SiO₄)/PO₄ tetrahedra. The entrances to the voids are formed from 8, 10 or 12 ring atoms with respect to the metal atoms which form the entrance opening, wherein a person skilled in the art uses the terms narrow-, average- and wide-pored structures here. According to the invention narrow-pored structures are preferred here. These titano-(silico)-alumino-phosphates can have a uniform structure, e.g. a VFI or AET topology with linear channels, wherein other topologies are however also conceivable, in which larger voids attach themselves behind the pore openings. The titano-(silico)-alumino-phosphates preferred according to the invention with openings made of eight tetrahedron atoms are—as already mentioned—narrow-pored materials, which preferably have an opening diameter of approximately 3.1 to 5 Å.

By the term “molecular sieve” is meant natural and synthetically produced framework structures with voids and channels, such as for example zeolites and related materials which have a high absorption capability for gases, vapours and dissolved substances with specific molecular sizes.

The step of the thermal conversion of the mixture containing a titanium source, an aluminium source, a phosphorus source and optionally a silicon source is preferably carried out at a temperature in the range of from 100 to 200° C., more preferably at a temperature in the range of from 150 to 200° C. and particularly preferably at a temperature of from 170 to 190° C.

The step of the thermal conversion in the method according to the invention preferably takes place within a period in the range of from 12 to 120 hours, particularly preferably in the range of from 20 to 100 hours and most preferably in the range of from 24 to 72 hours.

All materials that can provide units for titano-(silico)-alumino-phosphates come into consideration as aluminium source in the method according to the invention, such as for example hydrogenated aluminium oxide, organic aluminium compounds (in particular aluminium isopropylate), pseudoboehmite, aluminium hydroxide, colloidal aluminium oxide, aluminium carboxylates, aluminium sulphates and mixtures thereof. Aluminium hydroxide in the form of a hydrargillite powder has proved particularly suitable. The hydrargillite powder to be used in this embodiment is not limited specifically. Thus, for example, aluminium hydroxide SH10, obtainable from Aluminium Oxid Stade GmbH, Germany, can be used as hydrargillite powder. It is particularly preferred that the hydrargillite powder has an average particle size in the range of from 5 μm to 200 μm, more preferably in the range of from 5 μm to 150 μm and most preferably in the range of from 5 μm to 100 μm.

Phosphoric acid, organic phosphates, aluminium phosphates and mixtures thereof are suitable as phosphorus source in the method according to the invention. Phosphoric acid is preferred according to the invention.

It was surprisingly found that titanium dioxide and/or silicon-doped titanium dioxide are particularly suitable as titanium source for producing titano-(silico)-alumino-phosphates. The use of these materials as titanium source in the method according to the invention results in a molecular sieve which has a particularly high phase purity.

The use of titanium dioxide and/or silicon-doped titanium dioxide as titanium source, unlike the methods of the state of the art, also has the advantage that no environmentally damaging titanium organyls are used. In this way, the waste waters are not loaded with organic compounds.

A silicon source can, as already mentioned, optionally also be used in the method according to the invention, if a titano-alumino-silico-phosphate is to be produced instead of a titano-alumino-phosphate. Any silicon source known to a person skilled in the art is suitable as silicon source, such as e.g. silicon dioxide gel, pyrogenic silicic acid, precipitated silicic acid, organic silicon compounds, sodium silicates, aluminosilicates, silicon-doped titanium dioxide or mixtures thereof.

If a silicon-doped titanium dioxide is used to produce a titano-alumino-silico-phosphate, it can be regarded as both silicon source and titanium source. In addition to these silicon and titanium sources, however, further silicon sources or titanium sources can also be used.

A mixture of silicon dioxide gel or pyrogenic silicic acid in the form of an SiO₂ powder (with a preferred purity of at least 99%) and a silicon-doped titanium dioxide powder has proved particularly suitable according to the invention as silicon or titanium source respectively.

As already mentioned, organo-free raw materials, such as silicon dioxide (both as sol and as pure substance) and titanium dioxide, which are also particularly suitable as mixed oxides for the synthesis of titano-(silico)-alumino-phosphates, are particularly preferred according to the invention. By organo-free raw materials are meant metal compounds which have no hydrocarbon-containing components, such as fall within the scope of organic chemistry according to the general understanding of a person skilled in the art. Organic components have a substantial risk potential both during the synthesis gel preparation and during the crystallization phase: They can decompose to explosive compounds under certain circumstances. In addition, the organic load in the waste water, which can only be removed again with great outlay, is increased.

In addition, the use of silicon and titanium dioxide compounds is therefore also particularly suitable, because they do not represent salts. The use of titanium salts, such as for example titanium sulphate, brings with it the disadvantage that the salt load in the waste water must be removed by elaborate purification steps.

By a template is meant in the present invention compounds, in particular organic compounds, which can force desired macromolecular structures in targeted manner during self-organized growth processes, in particular crystallization. In other words, the template results in the void structure, desired according to the invention, of titano-(silico)-alumino-phosphates being achieved. In the method according to the invention, any template known to a person skilled in the art for producing silico-alumino-phosphates can be used as template, such as e.g. tetramethylammonium, tetraethylammonium, tetrapropylammonium or tetrabutylammonium ions, in particular hydroxides, di-n-propylamine, tripropylamine, triethylamine, triethanolamine, piperidine, cyclohexylamine, 2-methylpyridine, N,N-dimethylbenzylamine, N,N-diethylethanolamine, dicyclohexylamine, N,N-dimethylethanolamine, choline, N,N′-dimethylpiperazine, 1,4-diazabicyclo(2,2,2)octane, N-dimethyldiethanolamine, N-methylethanolamine, N-methylpiperidine, 3-methylpiperidine, N-methylcyclohexylamine, 3-methylpyridine, 4-methylpyridine, quinuclidine, N,N′-dimethyl-1,4-diazabicyclo(2,2,2)octane ion, di-n-butylamine, neopentylamine, di-n-pentylamine, isopropylamine, t-butylamine, ethylenediamine, pyrrolidine and 2-imidazolidone. According to a particularly preferred embodiment of the method according to the invention, however, tetraethylammonium hydroxide (TEACH) is used as template.

The mixture comprising a titanium source, an aluminium source, a phosphorus source and optionally a silicon source of the method according to the invention is preferably a mixture of the named substances in a solvent. Organic alcohols and water are suitable as solvents. The following solvents are preferably used according to the invention: hexanol, ethanol and water. Water is particularly preferred as solvent.

The step of thermal conversion in the method according to the invention is preferably followed by a step of isolating the titano-(silico)-alumino-phosphate. The isolation of the titano-(silico)-alumino-phosphate from the reaction mixture preferably takes place by evaporation, fritting, filtering, rotary evaporation, decanting, sedimenting, centrifuging, preferably by filtering.

The isolated titano-(silico)-alumino-phosphate is preferably subsequently washed with water until the conductivity of the washing water is less than 100 μS/cm.

The isolated titano-(silico)-alumino-phosphate is advantageously dried at temperatures above 50° C., preferably of more than 100° C. This temperature is preferably maintained during a period of from 1 hour to 24 hours, preferably 8 to 12 hours. The times are chosen such that the titano-(silico)-alumino-phosphate is dried to constant weight.

The reaction product is preferably calcined over a period of from 1 hour to 10 hours, preferably 2 hours to 7 hours, because if the chosen times are too short organic and inorganic impurities are not removed from the pores of the framework structure. The calcining of the titano-(silico)-alumino-phosphate is therefore to be carried out at a temperature of from 100 to 1,000° C., preferably at a temperature of from 200 to 700° C., to remove all impurities while obtaining the framework structure. The calcining can be carried out both under protective gas atmosphere, such as e.g. a nitrogen, helium, neon and argon atmosphere, and under air. The principle purpose of the calcining lies in the burning out and associated removal of the template compound.

It is particularly preferred that the titano-(silico)-alumino-phosphate produced according to the invention is a substantially sodium-free molecular sieve. The term “substantially” here is intended to signify that minimal sodium impurities, which cannot be avoided because of the unintentional presence of sodium in the starting substances, can be present in the molecular sieve. Sodium-free sources for the starting compounds are therefore preferably used in the method according to the invention, in particular sodium-free silicon and titanium oxide compounds. Thus, the advantage results that, after the removal of the template, the protonated form of the titano-(silico)-alumino-phosphate is directly present. In this way, several process steps are dispensed with, such as for example the repeated ion exchange to produce a proton- or metal-exchanged molecular sieve with ammonium ions, which is followed by further steps such as filtration, drying and calcining of the ammonium form of the titano-(silico)-alumino-phosphate to produce the protonated form.

In a further step of the method according to the invention for producing the titano-(silico)-alumino-phosphate, the charge-neutralized protons inside the framework structure are preferably replaced by metal cations which give the structure the catalytic properties. This ion exchange can be carried out both in liquid and in solid form. In addition, gas phase exchanges are known, which are however too expensive for industrial processes. A disadvantage with the present state of the art is that in the case of solid ion exchange, although a defined quantity of metal ions can be introduced into the titano-(silico)-alumino-phosphate framework, there is no homogeneous distribution of the metal ions. By contrast, in the case of liquid ion exchange a homogeneous metal ion distribution in the titano-(silico)-alumino-phosphate can be achieved. However, in the case of liquid aqueous ion exchange a disadvantage with small-pored titano-(silico)-alumino-phosphates is that the hydration sheath of the metal ions is too big for the metal ions to be able to penetrate the small pore openings and the exchange rate is thus only very low. In other words, after the drying of the titano-(silico)-alumino-phosphate produced according to the invention, the latter is preferably doped with one or more transition metals or noble metals. In addition to the named methods, the doping can be carried out with one or more metals by aqueous impregnation or the incipient wetness method. These doping methods are known in the state of the art. Insofar as the size of the hydration sheath of the respective metal ion allows it, it is particularly preferred that the doping is carried out by means of one or more metal compounds by aqueous ion exchange.

The sodium-free titano-(silico)-alumino-phosphate produced according to the invention has proved particularly suitable for ion exchange with metals. The protonated form can be exchanged with metal ions more easily than the sodium form, because in this case the sodium ions would have to be exchanged with ammonium ions first, before the latter can in turn be exchanged with metals. As a result of the repeated exchange, the molecular sieve cannot be completely occupied by the desired metal ions.

The metal-containing titano-(silico)-alumino-phosphate produced according to the invention is eminently suitable as catalyst and as absorbent because of its high phase purity, its temperature stability, its very high level of charge with metal and its high storage capacity.

The titano-(silico)-alumino-phosphate produced according to the invention can be charged with any ionic metal-containing compounds or metal ions. The titano-(silico)-alumino-phosphate produced according to the invention is preferably charged with a transition metal cation.

The titano-silico-alumino-phosphates produced with the method according to the invention are preferably selected from TAPSO-5, TAPSO-8, TAPSO-11, TAPSO-16, TAPSO-17, TAPSO-18, TAPSO-20, TAPSO-31, TAPSO-34, TAPSO-35, TAPSO-36, TAPSO-37, TAPSO-40, TAPSO-41, TAPSO-42, TAPSO-44, TAPSO-47, TAPSO-56. TAPSO-5, TAPSO-11 or TAPSO-34 are particularly preferred as these have a particularly high hydrothermal stability vis-à-vis water. TAPSO-5, TAPSO-11 and TAPSO-34 are also particularly suitable due to their good properties as catalyst in different processes because of their microporous structure and because they are highly suitable as adsorbents due to their high adsorption capacity. Moreover, they also have a low regeneration temperature, as they already reversibly release adsorbed water or adsorbed other small molecules at temperatures between 30° C. and 90° C. According to the invention the use of microporous titano-silico-alumino-phosphates with CHA structure is particularly suitable. The molecular sieve produced according to the invention is quite particularly preferably a so-called TAPSO-34, as is known in the state of the art for example from EP 161 488 and U.S. Pat. No. 4,684,617.

The titano-(silico)-alumino-phosphate produced and used according to the invention is particularly preferably one with the following formula:

[(TiₓAl_{y}Si_{z}P_{q})O₂]^{-a}[M^{b+}]_{a/b},

wherein the symbols and indices used have the following meanings: x+y+z+q=1; 0.010≦x≦0.110; 0.400≦y≦0.550; 0≦z≦0.090; 0.350≦q≦0.500; a=y−q (wherein y is preferably greater than q); M^{b+} represents the transition metal cation with the charge b+, wherein b is an integer greater than or equal to 1, preferably 1, 2, 3 or 4, even more preferably 1, 2 or 3 and most preferably 1 or 2.

The number of negative charges a of the molecular sieve is obtained from the number of aluminium atoms in excess of the number of phosphorus atoms. If it is assumed that there are two oxygen atoms to each Ti, Al, Si and P atom, these units would then have the following charges: The unit TiO₂ and the unit SiO₂ are neutral in charge, the unit AlO₂ has a negative charge due to the trivalency of aluminium and the unit PO₂ has a positive charge due to the pentavalency of phosphorus. It is particularly preferable according to the invention that the number of aluminium atoms is greater than the number of phosphorus atoms, with the result that the molecular sieve is negatively charged overall. In the above-named formula this is expressed by the index a, which represents the difference of the aluminium atoms present minus the phosphorus atoms. This is therefore in particular the case, as neutrally charged TiO₂ or SiO₂ units are substituted for positively charged PO₂⁺ units.

In addition to the named SiO₂, TiO₂, AlO₂⁻ and PO₂⁺ units which form the framework of the molecular sieve and the ratio of which determines the valency of the molecular sieve, the molecular sieve can also contain Al and P units which, as such, are formally to be regarded as neutral in charge, for example, because it is not O₂⁻ units that occupy the coordination sites, but because other units, such as for example OH⁻ or H₂O, are situated at this site, preferably if they are present at the terminal or edge position in the structure. This portion of these units is then referred to as the so-called “extra framework” of the molecular sieve. Octahedrally coordinated aluminium atoms can also be present as “extra framework” aluminium.

According to a particularly preferred embodiment, the titano-(silico)-alumino-phosphate produced and used according to the invention has an (Si+Ti)/(Al+P) molar ratio of 0.01-0.5 to 1, more preferably 0.02-0.4 to 1, even more preferably 0.05-0.3 to 1 and most preferably 0.07-0.2 to 1.

The Si/Ti ratio preferably lies within the range of from 0 to 20, more preferably within the range of from 0 to 10. The Al/P ratio with respect to all the units of the molecular sieve, i.e., those of the framework and of the extra framework of the titano-(silico)-alumino-phosphate, preferably lies within the range of from 0.5 to 1.5, more preferably within the range of from 0.70 to 1.25. The Al/P ratio only with respect to the framework of the titano-(silico)-alumino-phosphate preferably lies within the range of from greater than 1 to 1.5, more preferably within the range of from 1.05 to 1.25.

If the titano-(silico)-alumino-phosphate is present in transition metal-modified form (i.e. the transition metal is present in the form of a cation as counterion for the negatively charged molecular sieve), it preferably has a metal content, calculated as oxide, of from 1 wt. % to 10 wt. %, preferably 2 to 8 wt. %, more preferably 3 to 6 wt. % and most preferably 4 to 5 wt. %.

A further embodiment of the present invention relates to a titano-(silico)-alumino-phosphate which has been produced according to the method according to the invention.

In a further embodiment, the present invention relates to a titano-(silico)-alumino-phosphate containing at least one catalytically active component. The catalytically active component is preferably a transition metal ion or a compound of a transition metal in the form of an ion inside the framework structure to equalize the charge of the negatively charged molecular sieve. The above-named metal ions or ionic metal-containing compounds are for example the named catalytically active components. In a preferred embodiment, the titano-(silico)-alumino-phosphate preferably contains the transition metal in the range of from 5 to 95 wt. %, more preferably in the range of from 20 to 80 wt. %, relative to the total mass of the titano-(silico)-alumino-phosphate with the catalytically active component. Furthermore, the titano-(silico)-alumino-phosphate can preferably be processed into a catalytically active composition by the addition of metal oxides, binders, promoters, stabilizers and/or fillers. The molecular sieve in any embodiment of the present invention can be a titano-(silico)-alumino-phosphate as described in the state of the art, but it can also be a special titano-(silico)-alumino-phosphate produced according to the method according to the invention, i.e. the preferred features named in connection with the titano-(silico)-alumino-phosphate produced according to the invention can also apply to the conventional titano-(silico)-alumino-phosphate—insofar as possible on the basis of the difference.

The titano-(silico)-alumino-phosphates produced according to the invention and known in the state of the art that are preferably metal-exchanged can be processed for example into a so-called washcoat which is suitable for coating catalyst supports or catalyst shaped bodies. Such a washcoat preferably comprises 5 to 70 wt. %, more preferably 10 to 50 wt. %, particularly preferably 15 to 50 wt. % titano-(silico)-alumino-phosphate according to the invention relative to the pure portions, namely titanium, aluminium, silicon, phosphorus and oxygen. The washcoat according to the invention additionally contains a binder and a solvent. The binder, when applied to a catalyst shaped body, serves to bind the molecular sieve. The solvent serves to allow both the molecular sieve and the binder to be applied to the catalyst support in the form of a coating. As an alternative to the use as washcoat and application to a catalyst support, the titano-(silico)-alumino-phosphates in powder form, in particular for stationary applications, can be shaped into extrudates.

Mobile applications are preferred as possible applications applied to a catalyst support in the form of a washcoat. Structured and unstructured ceramic or metallic honeycombs are suitable as catalyst support.

As a further embodiment, the present invention thus also relates to a catalyst support containing a titano-(silico)-alumino-phosphate (according to the invention or conventional). In this titano-(silico)-alumino-phosphate, the counterions are preferably formed by metal cations.

The metal-containing titano-(silico)-alumino-phosphate according to the invention can preferably also be processed into a catalyst of any extruded shape, preferably honeycomb shape, by extrusion.

In a further embodiment of the present invention, the titano-(silico)-alumino-phosphate produced according to the invention can be used both in its powder form and as shaped body as absorbent either in metal-doped form or in non-doped form.

In a further embodiment of the present invention, the washcoat according to the invention is used to produce a catalyst. In this case, the washcoat according to the invention is preferably applied to a catalyst support—as described above.

A further embodiment according to the invention relates to the use of a titano-(silico)-alumino-phosphate or a catalyst shaped body according to the invention to produce a catalyst.

It was surprisingly found that the molecular sieve according to the invention has a greater thermal stability in the aqueous phase than previously known molecular sieves of the same type not containing titanium. The high stability of the molecular sieve according to the invention vis-à-vis hydrothermal stress, above all at temperatures in the range of from 50 to 100° C., is very advantageous. For the stress test, the titano-silico-alumino-phosphate (TAPSO-34) and a silico-alumino-phosphate (SAPO-34) were treated in water at 30° C., 50° C., 70° C. and 90° C. for 72 h. The material was then filtered off, dried at 120° C. and the BET surface area was ascertained. While the molecular sieves not according to the invention that do not contain titanium, the so-called SAPOs, already lose their structure at 50° C. and become amorphous at 70° C., the molecular sieve according to the invention retains its structure even at 70° C. with almost constant BET surface area. The results are summarized in the following Table 1:

TABLE 1

| | BET surface area | BET surface area |
|---|---|---|
| Treatment | of TAPSO-34 | of SAPO-34 |
| temperature/° C. | per m²/g | per m²/g |
| Untreated | 632 | 557 |
| 30 | 626 | 429 |
| 50 | 619 | 108 |
| 70 | 604 | 8 |
| 90 | 320 | 0 |

In a further embodiment, the present invention also relates to a catalyst that contains a titano-(silico)-alumino-phosphate or a catalyst shaped body (=catalyst support) which comprises a titano-(silico)-alumino-phosphate.

The titano-(silico)-alumino-phosphate in the catalyst support according to the invention or the washcoat according to the invention can be one according to the method of the state of the art or one which was produced according to the method according to the invention.

The invention is explained in more detail below with the help of some examples, which are not to be understood as limiting.

### EXAMPLE 1

100.15 parts by weight of deionized water and 88.6 parts by weight of hydrargillite (aluminium hydroxide SH10, available from Aluminium Oxid Stade GmbH, Germany) were mixed. 132.03 parts by weight of phosphoric acid (85%) and 240.9 parts by weight of TEAOH (tetraethylammonium hydroxide) (35% in water) and then 33.5 parts by weight of silica sol (Köstrosol 1030, 30% silicon dioxide, available from CWK Chemiewerk Bad Köstriz, Germany) and 4.87 parts by weight of silicon-doped titanium dioxide (TiO₂ 545 S, Evonik, Germany) were added to the obtained mixture.

A synthesis gel mixture with the following molar composition was obtained:

Al₂O₃:P₂O₅:0.3 SiO₂:0.1 TiO₂:1 TEAOH:35 H₂O

The synthesis gel mixture with the above composition was transferred into a stainless-steel autoclave. The autoclave was stirred and heated to 180° C., wherein this temperature was maintained for 68 hours. After cooling the obtained product was filtered off, washed with deionized water and dried in the oven at 100° C. An X-ray diffractogram of the obtained product showed that the product was pure TAPSO-34. The elemental analysis revealed a composition of 1.5% Ti, 2.8% Si, 18.4% Al and 17.5% P, which corresponds to a stoichiometry of Ti_{0.023}Si_{0.073}Al_{0.494}P_{0.410}. According to an SEM (scanning electron microscope) analysis of the product, its crystal size lay in the range of from 0.5 to 2 μm.

### EXAMPLE 2

361.9 parts by weight of deionized water and 294.77 parts by weight of hydrargillite (aluminium hydroxide SH10, available from Aluminium Oxid Stade GmbH, Germany) were mixed. 439.27 parts by weight of phosphoric acid (85%) and 801.55 parts by weight of TEAOH (35% in water) and then 70.26 parts by weight of silica sol (Köstrosol 1030, 30% silicon dioxide, available from CWK Chemiewerk Bad Köstriz, Germany) and 32.26 parts by weight of silicon-doped titanium dioxide (TiO₂ 545 S, Evonik, Germany) were added to the obtained mixture.

A synthesis gel mixture with the following molar composition was obtained:

Al₂O₃:P₂O₅:0.2 SiO₂:0.2 TiO₂:1 TEAOH:35 H₂O

The synthesis gel mixture with the above composition was transferred into a stainless-steel autoclave. The autoclave was stirred and heated to 180° C., wherein this temperature was maintained for 17 hours. After cooling the obtained product was filtered off, washed with deionized water and dried in the oven at 100° C. An X-ray diffractogram of the obtained product showed that the product was pure TAPSO-34. The elemental analysis revealed a composition of 2.8% Ti, 1.8% Si, 17.3% Al and 16.3% P, which corresponds to a stoichiometry of Ti_{0.047}Si_{0.050}Al_{0.496}P_{0.407}. According to an SEM (scanning electron microscope) analysis of the product, its crystal size lay in the range of from 0.5 to 2 μm.

### EXAMPLE 3

153.04 parts by weight of deionized water and 30.46 parts by weight of silicon dioxide (Elkem Submicron Silica 995, amorphous silicon dioxide with a purity of 99.997%, average particle size d100>4 μm, BET surface area=50 m²/g, available from Elkem Materials, Norway) were mixed. Furthermore, a mixture of 217.16 parts by weight of deionized water and 265.82 parts by weight of hydrargillite (aluminium hydroxide SH10, available from Aluminium Oxid Stade GmbH, Germany) was produced, to which 396.12 parts by weight of phosphoric acid (85%) and 722.85 parts by weight of TEAOH (tetraethylammonium hydroxide) (35% in water) were added. The silicon dioxide/water mixture produced in the above-described manner was added to the obtained hydrargillite mixture. 14.54 parts by weight of TiO₂ (545 S, Evonik, Germany) were then added, with the result that a synthesis gel mixture with the following molar composition was obtained:

Al₂O₃:P₂O₅:0.3 SiO₂:0.1 TiO₂:1 TEAOH:35 H₂O

The synthesis gel mixture with the above composition was transferred into a stainless-steel autoclave. The autoclave was stirred and heated to 180° C., wherein this temperature was maintained for 67 hours. After cooling the obtained product was filtered off, washed with deionized water and dried in the oven at 100° C. An X-ray diffractogram of the obtained product showed that the product was pure TAPSO-34. The elemental analysis revealed a composition of 2.7% Si, 1.84% Ti, 19.0% Al and 16.7% P, which corresponds to a stoichiometry of Ti_{0.028}Si_{0.070}Al_{0.511}P_{0.391}. According to an SEM (scanning electron microscope) analysis of the product, its crystal size lay in the range of from 1 to 3 μm.

### EXAMPLE 4

246.73 parts by weight of deionized water and 265.76 parts by weight of hydrargillite (aluminium hydroxide SH10, available from Aluminium Oxid Stade GmbH, Germany) were mixed. 448.85 parts by weight of phosphoric acid (75%) and 722.71 parts by weight of TEAOH (35% in water) and then 100.96 parts by weight of silica sol (Köstrosol 1030, 30% silicon dioxide, available from CWK Chemiewerk Bad Köstriz, Germany) and 14.99 parts by weight of silicon-doped titanium dioxide (TiO₂ 545, Evonik, Germany) were added to the obtained mixture.

A synthesis gel mixture with the following molar composition was obtained:

Al₂O₃:P₂O₅:0.3 SiO₂:0.1 TiO₂:TEAOH:35 H₂O

The synthesis gel mixture with the above composition was transferred into a stainless-steel autoclave. The autoclave was stirred and heated to 180° C., wherein this temperature was maintained for 60 hours. After cooling the obtained product was filtered off, washed with deionized water and dried in the oven at 120° C. An X-ray diffractogram of the obtained product showed that the product was pure TAPSO-34. The elemental analysis revealed a composition of 1.58% Ti, 2.65% Si, 17.0% Al and 16.5% P, which corresponds to a stoichiometry of Ti_{0.026}Si_{0.073}Al_{0.488}P_{0.413}. According to an SEM (scanning electron microscope) analysis of the product, its crystal size lay in the range of from 0.5 to 2 μm.

### EXAMPLE 5

244.84 parts by weight of deionized water and 265.76 parts by weight of hydrargillite (aluminium hydroxide SH10, available from Aluminium Oxid Stade GmbH, Germany) were mixed. 448.85 parts by weight of phosphoric acid (75%) and 722.70 parts by weight of TEAOH (35% in water) and then 103.22 parts by weight of silica sol (Köstrosol 1030, 30% silicon dioxide, available from CWK Chemiewerk Bad Köstriz, Germany) and 14.65 parts by weight of titanium dioxide (TiO₂ P 25, Evonik, Germany) were added to the obtained mixture.

A synthesis gel mixture with the following molar composition was obtained:

Al₂O₃:P₂O₅:0.3 SiO₂:0.1 TiO₂:TEAOH:35 H₂O

The synthesis gel mixture with the above composition was transferred into a stainless-steel autoclave. The autoclave was stirred and heated to 180° C., wherein this temperature was maintained for 60 hours. After cooling the obtained product was filtered off, washed with deionized water and dried in the oven at 120° C. An X-ray diffractogram of the obtained product showed that the product was pure TAPSO-34. The elemental analysis revealed a composition of 1.52% Ti, 2.39% Si, 15.5% Al and 15.7% P, which corresponds to a stoichiometry of Ti_{0.026}Si_{0.011}Al_{0.480}P_{0.423}. According to an SEM (scanning electron microscope) analysis of the product, its crystal size lay in the range of from 0.5 to 2 μm.

### EXAMPLE 6

290.73 parts by weight of deionized water and 278.61 parts by weight of hydrargillite (aluminium hydroxide SH10, available from Aluminium Oxid Stade GmbH, Germany) were mixed. 415.19 parts by weight of phosphoric acid (75%) and 757.64 parts by weight of TEAOH (35% in water) and 57.84 parts by weight of titanium dioxide (TiO₂ P 25/20, Evonik, Germany) and 10.00 parts by weight of seeds which are suitable for synthesizing TAPO-34 were added to the obtained mixture.

A synthesis gel mixture with the following molar composition was obtained:

Al₂O₃:P₂O₅:0.4 TiO₂:TEAOH:32 H₂O

The synthesis gel mixture with the above composition was transferred into a stainless-steel autoclave. The autoclave was stirred and heated to 180° C., wherein this temperature was maintained for 80 hours. After cooling the obtained product was filtered off, washed with deionized water and dried in the oven at 120° C. An X-ray diffractogram of the obtained product showed that the product was pure TAPO-34. The elemental analysis revealed a composition of 4.1% Ti, 15.2% Al and 16.1% P, which corresponds to a stoichiometry of Ti_{0.074}Al_{0.482}P_{0.444}. According to an SEM (scanning electron microscope) analysis of the product, its crystal size lay in the range of from 0.5 to 2.5 μm.

1-13. (canceled)

14. A method for producing a titano-alumino-phosphate or a titano-silico-alumino-phosphate by thermal conversion of a mixture comprising a titanium source, an aluminium source, a phosphorus source and optionally a silicon source, wherein the titanium source comprises TiO₂ and/or silicon-doped TiO₂.

15. The method according to claim 14, wherein the mixture contains a template.

16. The method according to claim 14, wherein the silicon source comprises SiO₂ and the titanium source comprises silicon-doped TiO₂.

17. The method according to claim 14, wherein the titano-alumino-phosphate or the titano-silico-alumino-phosphate is substantially sodium-free.

18. The method according to claim 14, wherein the titano-alumino-phosphate or the titano-silico-alumino-phosphate has the following formula:
[(TiₓAl_{y}Si_{z}P_{q})O₂]^{-a}[M^{b+}]_{a/b,}
wherein the symbols and indices used have the following meanings: x+y+z+q)=1; 0.010≦x≦0.110; 0.400≦y≦0.550; 0≦z≦0.090; 0.350≦q≦0.500; a=y−q; M^{b+} represents a transition metal cation with a charge b+, wherein b is an integer greater than or equal to 1.

19. The method according to claim 14, wherein the titano-silico-alumino-phosphate is TAPSO-34.

20. The method according to claim 14, wherein the step of the thermal conversion of the mixture is carried out at a temperature within the range of from 100 to 200° C.

21. The method according to claim 14, wherein the step of thermal conversion takes place within a period in the range of from 12 to 120 hours.

22. The method according to claim 14, wherein, using liquid ion exchange, metal cations are bound as counterions of the titano-alumino-phosphate or of the titano-silico-alumino-phosphate.

23. A catalyst shaped body containing a titano-alumino-phosphate or a titano-silico-alumino-phosphate.

24. The catalyst shaped body according to claim 23, wherein the titano-alumino-phosphate or the titano-silico-alumino-phosphate contains metal cations as counterions.

25. A washcoat containing a titano-alumino-phosphate or a titano-silico-alumino-phosphate, a binder and a solvent.

26. A method for producing a catalyst utilizing a titano-alumino-phosphate or titano-silico-alumino-phosphate produced according to claim 14.

27. A method for producing a catalyst utilizing a catalyst shaped body according to claim 23.

28. A method for producing a catalyst utilizing a washcoat according to claim 25.
